(19) United States
(12) Patent Application Publication
(10) Pub. No.: US 2024/0331259 A1
(43) Pub. Date: Oct. 3, 2024

(54) DISPLAY CONTROL CHIP, OPERATING METHOD THEREOF AND DISPLAY SYSTEM COMPRISING THE SAME

(71) Applicant: Realtek Semiconductor Corporation, Hsinchu (TW)

(72) Inventors: Yung-Chih CHEN, Hsinchu (TW); Wei-Chih LIN, Hsinchu (TW); Jui-Te WEI, Hsinchu (TW); Po-An CHEN, Hsinchu (TW)

(21) Appl. No.: 18/448,177

(22) Filed: Aug. 11, 2023

(30) Foreign Application Priority Data
Mar. 31, 2023 (TW) 112112681

(51) Int. Cl. G06T 13/80

(52) U.S. Cl. CPC G06T 13/80

(57) ABSTRACT

A display control chip comprises a computing circuit and an on-screen display (OSD) buffer. The computing circuit is configured to receive update data, and is configured to use the update data to update animation data in a memory. The animation data comprises a plurality of images. The OSD buffer is coupled with the computing circuit. When the computing circuit reads the animation data in the memory, the computing circuit is configured to sequentially write the plurality of images into the OSD buffer. The OSD buffer is configured to sequentially output the plurality of images to a display circuit to form an OSD animation on the display circuit.

### RELATED APPLICATIONS

This application claims priority to Taiwan Application Serial Number 112112681, filed on Mar. 31, 2023, which is herein incorporated by reference in its entirety.

### BACKGROUND

### Technical Field

Present disclosure is related to an on-screen display (OSD) technology. More particularly, the present disclosure is related to a display control chip, an operating method and a display system that are able to customize and adjust OSD information.

### Description of Related Art

On-screen display (OSD) information is built into the firmware of the display device, thus the display device is still able to display OSD information when it is not connected to a video signal source. The OSD information is usually used as a control menu of the display device, so as to allow users to configure the functions of the display device. However, the OSD information of traditional display device cannot be modified after leaving the factory, thus limiting the application scenarios of the display device.

### SUMMARY

An operating method for a display control chip is provided in the present disclosure. The display control chip comprises an on-screen display (OSD) buffer. The operating method comprises the following steps: using update data to update animation data in a memory, wherein the animation data comprises a plurality of images; writing the plurality of images into the OSD buffer sequentially; and outputting the plurality of images to a display circuit sequentially to form an OSD animation on the display circuit.

A display control chip is provided in the present disclosure. The display control chip comprises a computing circuit and an OSD buffer. The computing circuit is configured to receive update data, and configured to use the update data to update animation data in a memory. The animation data comprises a plurality of images. The OSD buffer is coupled to the computing circuit. When the computing circuit reads the animation data in the memory, the computing circuit is configured to write the plurality of images into the OSD buffer sequentially. The OSD buffer is configured to output the plurality of images to a display circuit sequentially, so as to form an OSD animation on the display circuit.

A display system is provided in the present disclosure. The display system comprises a memory, an input device, a display circuit and a display control chip. The memory is configured to store animation data, and the animation data comprises a plurality of images. The input device is configured to generate update data. The display control chip comprises an OSD buffer, is configured to communicate with the input device for receiving the update data, and is configured to use the update data to update the animation data. The display control chip is coupled to the memory and the display circuit. When the display control chip reads the animation data in the memory, the display control chip is configured to: write the plurality of images into the OSD buffer sequentially; and output the plurality of images to the display circuit sequentially, so as to form an OSD animation on the display circuit.

One of the advantages of the aforementioned display control chip, operating method and display system is that customized information can be saved for a long time and be used to generate OSD animations able to be displayed repeatedly.

It should be understood that both the foregoing general description and the following detailed description are by examples, and are intended to provide further explanation of the disclosure as claimed.

### BRIEF DESCRIPTION OF THE DRAWINGS

FIG. 1 is a simplified functional block diagram of a display system in accordance with an embodiment of the present disclosure.

FIG. 2 is a flowchart of an operating method in accordance with an embodiment of the present disclosure.

FIG. 3 is a schematic diagram of animation data transmitting in accordance with an embodiment of the present disclosure.

FIG. 4 is a schematic diagram of animation data transmitting in accordance with an embodiment of the present disclosure.

FIG. 5 is a schematic diagram of image overlaying in accordance with an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

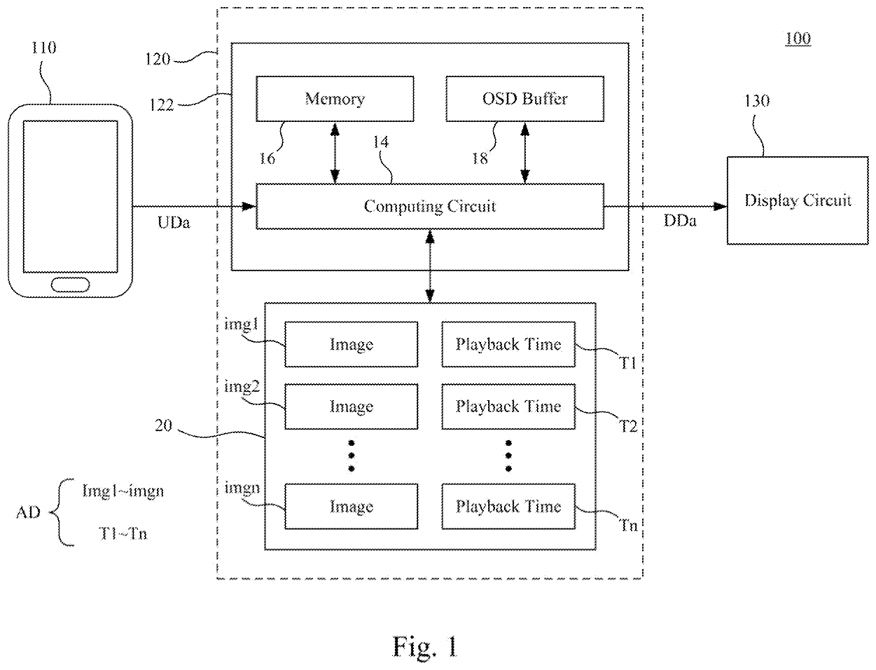

FIG. 1 is a simplified functional block diagram of a display system 100 in accordance with an embodiment of the present disclosure. The display system 100 comprises an input device 110, a control circuit 120 and a display circuit 130. The control circuit 120 is coupled between the input device 110 and the display circuit 130. The input device 110 and the control circuit 120 may be coupled to each other through various suitable wired or wireless transmission methods, such as universal serial bus (USB), Wi-Fi, Bluetooth, universal asynchronous receiver/transmitter (UART), wired network, etc.

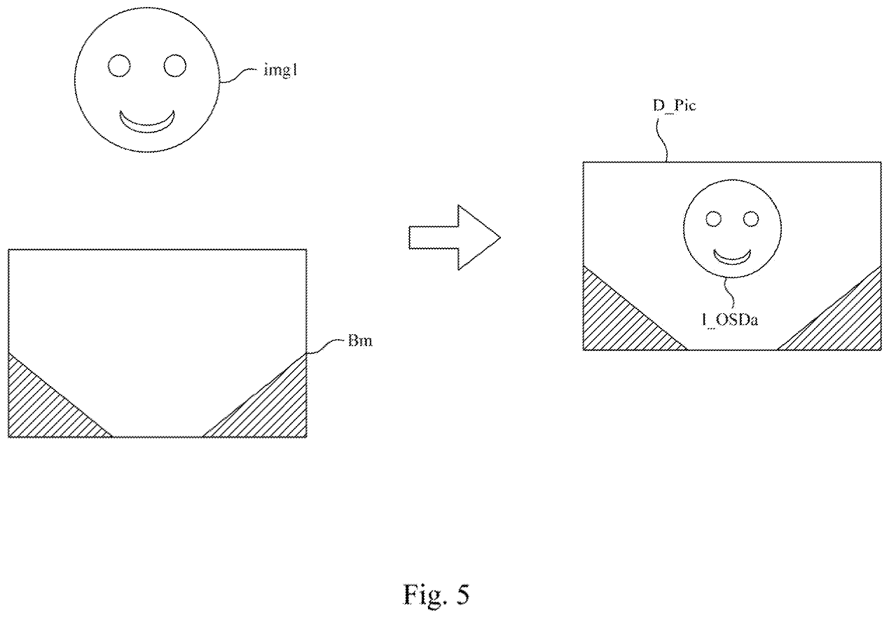

A display control chip 122 of the control circuit 120 comprises a computing circuit 14, a memory 16 and an on-screen display (OSD) buffer 18. The computing circuit 14 is coupled to the memory 16 and the OSD buffer 18, and is configured to access the memory 16, wherein the memory 16 is configured to store a background image Bm, and the background image Bm will be further described in conjunction with FIG. 5 in following paragraphs. The computing circuit 14 is configured to receive update data UDa from the input device 110, and configured to generate output results related to the update data UDa. The computing circuit 14 is further configured to temporarily store the output results in the OSD buffer 18. Next, the OSD buffer 18 may output the stored content as display data DDa to the display circuit 130, so as to control the display circuit 130 to use an OSD function to play animations. In some embodiments, the computing circuit 14 may receive video data from an external video source (not shown, such as a display card), thus the display data DDa outputted by the OSD buffer 18 may be related to the update data UDa and the video data.

In some embodiments, the display circuit 130 comprises a display panel, a data driving circuit, a scan driving circuit and a timing control circuit. The control circuit 120 and the display circuit 130 may be integrated into the same display device, such as a television, a computer screen or an electronic signage. In some embodiments, the OSD buffer 18 may be a volatile memory, such as a dynamic random access memory (DRAM) or a static random access memory (SRAM).

The computing circuit 14 may further access another memory 20 in the control circuit 120. The memory 20 is configured to store animation data AD, wherein the animation data AD may comprise images (e.g., images img1-imgn) and playback times (e.g., playback times T1-Tn) respectively corresponding to the images. The computing circuit 14 is configured to update the animation data AD by using the update data UDa. The computing circuit 14 is further configured to read the animation data AD, and control the display circuit 130 to display OSD animations through the OSD buffer 18 according to the animation data AD. In some embodiments, the memory 20 is a non-volatile memory, such as an electrically-erasable programmable read-only memory (EEPROM) or a flash memory.

In some embodiments, the display control chip 122 and the memory 20 are different circuits located on the same circuit board. In other embodiments, the memory 20 is a pluggable memory device (e.g., an USB flash drive), and is electrically connected to the display control chip 122 in a pluggable manner.

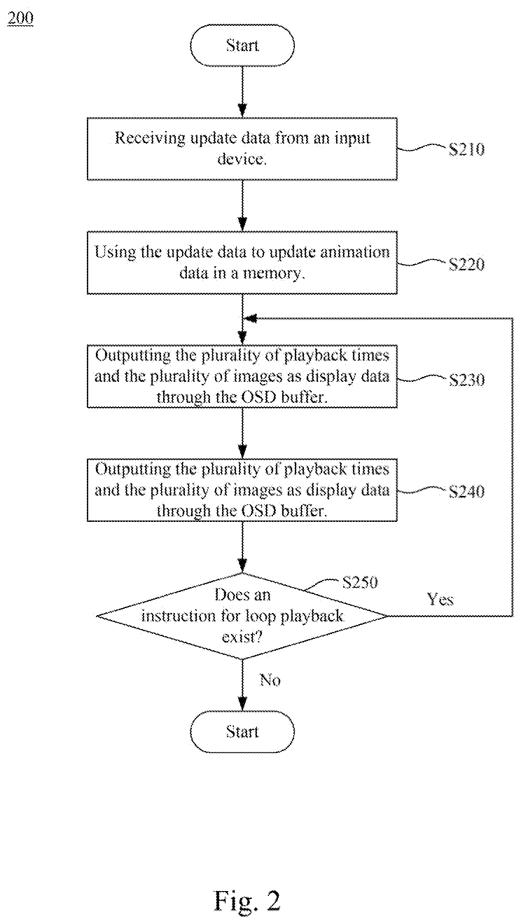

FIG. 2 is a flowchart of an operating method 200 in accordance with an embodiment of the present disclosure. The operating method 200 is applicable to the display control chip 122 of FIG. 1. In step S210, the computing circuit 14 is configured to receive the update data UDa from the input device 110. In step S220, the computing circuit 14 updates the animation data AD in the memory 20 by using the update data UDa.

In detail, the user can load a segment of animation into the input device 110, and the input device 110 is configured to convert the segment of animation into the continuous images img1-imgn. Next, the user can specify the respective playback times T1-Tn of the images img1-imgn on the display circuit 130 through the input device 110. The input device 110 transmits the images img1-imgn and the playback times T1-Tn as the update data UDa to the computing circuit 14. Next, the computing circuit 14 is configured to update (e.g., replaces) the images and the playback times of the present animation data AD by using the images img1-imgn and the playback times T1-Tn of the update data UDa. Therefore, after step S220, the animation data AD will comprise the images img1-imgn and the playback times T1-Tn. In some embodiments, the user can store the images img1-imgn into the input device 110 directly, thus the input device 110 does not need to have the function of converting an animation to continuous images.

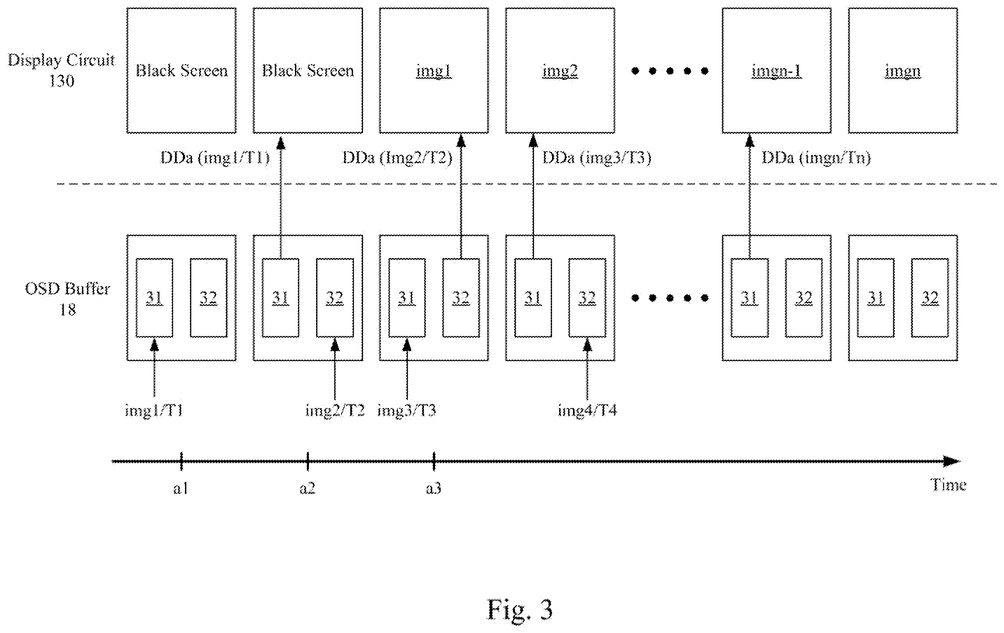

Please also refer to FIG. 3, wherein FIG. 3 is a schematic diagram of reading animation data AD in accordance with an embodiment of the present disclosure. In this embodiment, the OSD buffer 18 comprises a sub-buffer 31 and a sub-buffer 32. In step S230, the computing circuit 14 reads the animation data AD in the memory 20, and writes the images img1-imgn and the playback times T1-Tn into the OSD buffer 18 sequentially, and the sub-buffers 31 and 32 are configured to sequentially receive the images and the playback times written into the OSD buffer 18. Next, in step S240, the OSD buffer 18 outputs the images img1-imgn and the playback times T1-Tn sequentially as the display data DDa. In detail, the sub-buffers 31 and 32 are configured to sequentially output the images and the playback times stored therein as the display data DDa.

For example, at the time point a1, the image img1 and the playback time T1 are written into the sub-buffer 31; at the time point a2, the image img1 and the playback time T1 are outputted from the sub-buffer 31 as the display data DDa, and the image img2 and the playback time T2 are written into the sub-buffer 32; at the time point a3, the image img2 and the playback time T2 are outputted from the sub-buffer 32 as the display data DDa, and the image img3 and the playback time T3 are written into the sub-buffer 31, and so on.

In this case, the display circuit 130 uses the OSD function to display the image img1 for the playback time T1 (e.g., 0.1 second), and receives the display data DDa comprising the image img2 and the playback time T2 during the display of the image img1. Next, the display circuit 130 uses the OSD function to display the image img2 for the playback time T2 (e.g., 5 seconds), and receives the display data DDa comprising the image img3 and the playback time T3 during the display of the image img2, and so on. In some embodiments, when the display circuit 130 has not finished receiving the image img1, the display circuit 130 may display a default image, such as a black screen. It can be seen from the above that the playback times T1-Tn may be the same or different. In the case of a static image (e.g., the image img2) in the OSD animation to be displayed, the user can specify a longer playback time (e.g., the playback time T2 with a duration of 5 seconds), so as to reduce the update frequency of the display circuit 130 for saving power.

In some embodiments, the user does not need to specify the playback time on the input device 110. The computing circuit 14 can automatically generate default (e.g., the same) playback times T1-Tn when receiving the images img1-imgn.

The operating method 200 may comprise more or fewer steps than shown in the flowchart, and the steps of the operating method 200 may be performed in any suitable order. For example, steps S230 and S240 may be performed synchronously. In some embodiments, the operating method 200 further comprises step S250. In step S250, the computing circuit 14 determines whether an instruction for looping the animation is stored in the memory 20. If the determination is “Yes”, the computing circuit 14 may perform steps S230-S240 repeatedly. If the determination is “No”, the computing circuit 14 may end performing the operating method 200. In an embodiment, when the user selects the option of looping the animation on the input device 110, the input device 110 will transmit the instruction for looping the animation to the computing circuit 14 as a part of the update data UDa, which makes the computing circuit 14 store the instruction for looping the animation into the memory 20.

It is worth noting that the number of the sub-buffers in FIG. 3 is only an exemplary embodiment, and is not intended to limit the actual implementation of the present disclosure. In some embodiments, the OSD buffer 18 may comprise one or more sub-buffers.

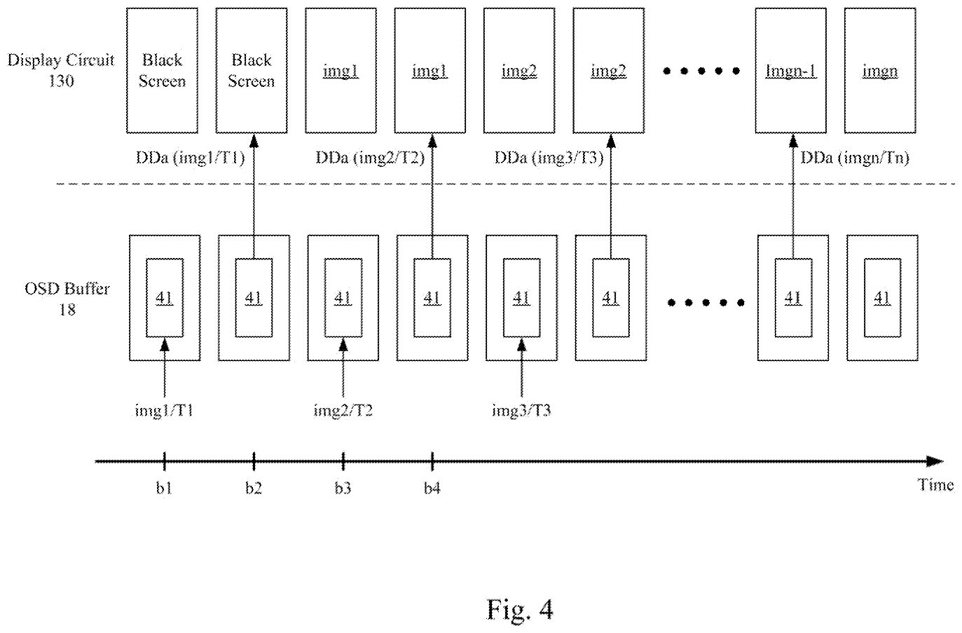

For example, please refer to FIG. 4, wherein FIG. 4 is a schematic diagram of reading animation data AD in accordance with an embodiment of the present disclosure. In this embodiment, the OSD buffer 18 has high reading speed and high writing speed, thus the OSD buffer 18 comprises only one sub-buffer 41. At the respective time points b1 and b2, the OSD buffer 18 writes the image img1 and the playback time T1 into the sub-buffer 41, and outputs the image img1 and the playback time T1 as the display data DDa. At the respective time points b3 and b4 (i.e., when the display circuit 130 is displaying the image img1), the OSD buffer 18 writes the image img2 and the playback time T2 into the sub-buffer 41, and outputs the image img2 and the playback time T2 as the display data DDa, and so on.

In the aforementioned embodiments, the OSD animation can completely fill the display area of the display circuit 130. In other embodiments below, the display circuit 130 may only use a part of the display area to display the OSD animation, thus the display control chip 122 may use additional images to fill the remaining display area of the display circuit 130.

Please refer to FIG. 5. FIG. 5 is a schematic diagram of image overlaying in accordance with an embodiment of the present disclosure. Before writing the image img1 into the OSD buffer 18, the computing circuit 14 can overlay the image img1 to the background image Bm first, and then write the result of image overlaying and the playback time T1 into the OSD buffer 18. Therefore, the OSD buffer 18 outputs the result of image overlaying and the playback time T1 as the display data DDa. In this case, the display circuit 130 provides a display picture D_Pic of FIG. 5 according to the display data DDa. The content of the display picture D_Pic is a new image generated by overlaying the image img1 to the background image Bm. In other words, the display picture D_Pic comprises the image img1 and the background image Bm at the same time, and the image img1 forms one frame of an OSD animation I_OSDa of the display picture D_Pic. The computing circuit 14 may perform the operations similar to the above to overlay the images img2-imgn to the background image Bm, and output these results of image overlaying respectively with the playback times T2-Tn as the display data DDa. For the sake of brevity, details are not repeated here.

In some embodiments, the computing circuit 14 receives video data from an external video source (not shown, e.g., a display card) and acquires the background image Bm from the video data in step S240. In some embodiments that the external video source does not exist, the background image Bm may be stored in the memory 16 or the memory 20.

In some embodiments, during the process of receiving the update data UDa and updating the animation data AD by the computing circuit 14 (i.e., during steps S210-S220), the computing circuit 14 may read a default image in the memory 16 and generate the display data according to the default image, so as to control the display circuit 130 to provide a display picture comprising the default image. The default image is used to inform the user that the computing circuit 14 is receiving the update data UDa. For example, the default image may comprise text such as “image sending”. In other embodiments, when the computing circuit 14 finish updating the animation data AD (i.e., finish performing step S220), the computing circuit 14 may read another default image in the memory 16, and control the display circuit 130 to provide a display picture comprising the another default image. The another default image is used to inform the user that the computing circuit 14 has finished updating the animation data AD. For example, the another default image may comprise text such as “image modified successfully”.

It can be known from the above that the display system 100 in FIG. 1 can store customized information for a long time. Even if the display device formed by the control circuit 120 and the display circuit 130 is powered off, the display device can still display the information previously stored by the user again when the display device is powered on next time. Therefore, the display system 100 has a high flexibility. For example, the management personnel of a company may push the information to be announced to each display device in the local network, through the main control computer of the local network, and in the form of OSD animation. For another example, by using OSD animation, individual users can use the display device at home as an electronic photo frame.

Certain terms are used in the specification and the claims to refer to specific components. However, those of ordinary skill in the art would understand that the same components may be referred to by different terms. The specification and claims do not use the differences in terms as a way to distinguish components, but the differences in functions of the components are used as a basis for distinguishing. Furthermore, it should be understood that the term “comprising” used in the specification and claims is open-ended, that is, including but not limited to. In addition, “coupling” herein includes any direct and indirect connection means. Therefore, if it is described that the first component is coupled to the second component, it means that the first component can be directly connected to the second component through electrical connection or signal connections including wireless transmission, optical transmission, and the like, or the first component is indirectly electrically or signally connected to the second component through other component(s) or connection means.

It will be understood that, in the description herein and throughout the claims that follow, the phrase “and/or” includes any and all combinations of one or more of the associated listed items. Unless the context clearly dictates otherwise, the singular terms used herein include plural referents.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. An operating method for a display control chip, wherein the display control chip comprises an on-screen display (OSD) buffer, the operating method comprises:
using update data to update animation data in a memory, wherein the animation data comprises a plurality of images;
writing the plurality of images into the OSD buffer sequentially; and
outputting the plurality of images to a display circuit sequentially to form an OSD animation on the display circuit.

2. The operating method of claim 1, wherein the OSD buffer comprises a plurality of sub-buffers, and writing the plurality of images into the OSD buffer sequentially comprises:
writing the plurality of images into the OSD buffer sequentially, wherein the plurality of sub-buffers are configured to sequentially receive the plurality of images written into the OSD buffer.

3. The operating method of claim 1, wherein the OSD buffer is configured to use the same sub-buffer to store the plurality of images sequentially.

4. The operating method of claim 1, wherein the animation data further comprises a plurality of playback times respectively corresponding to the plurality of images, and writing the plurality of images into the OSD buffer sequentially comprises:
writing the plurality of playback times respectively with the plurality of images into the OSD buffer sequentially.

5. The operating method of claim 1, wherein the memory is a pluggable memory device.

6. The operating method of claim 1, wherein outputting the plurality of images to the display circuit sequentially comprises:
overlaying a first image of the plurality of images to a background image to generate display data, wherein the background image is stored in the display control chip; and
outputting the display data to the display circuit.

7. The operating method of claim 1, wherein outputting the plurality of images to the display circuit sequentially comprises:
receiving a background image from an external video source;
overlaying a first image of the plurality of images to the background image to generate display data; and
outputting the display data to the display circuit.

8. The operating method of claim 1, further comprising:
in response to receiving the update data, outputting a default image of the display control chip to the display circuit.

9. A display control chip, comprising:
a computing circuit, configured to receive update data, and configured to use the update data to update animation data in a memory, wherein the animation data comprises a plurality of images; and
an on-screen display (OSD) buffer, coupled to the computing circuit;
wherein when the computing circuit reads the animation data in the memory, the computing circuit is configured to write the plurality of images into the OSD buffer sequentially,
the OSD buffer is configured to output the plurality of images to a display circuit sequentially, so as to form an OSD animation on the display circuit.

10. The display control chip of claim 9, wherein the OSD buffer comprises a plurality of sub-buffers, the computing circuit is configured to write the plurality of images into the OSD buffer sequentially, and the plurality of sub-buffers are configured to sequentially receive the plurality of images written into the OSD buffer.

11. The display control chip of claim 9, wherein the OSD buffer is configured to use the same sub-buffer to store the plurality of images sequentially.

12. The display control chip of claim 9, wherein the animation data further comprises a plurality of playback times respectively corresponding to the plurality of images, and the computing circuit is configured to write the plurality of playback times respectively with the plurality of images into the OSD buffer sequentially.

13. The display control chip of claim 9, wherein the computing circuit is configured to overlay a first image of the plurality of images to a background image to generate display data, and configured to output the display data to the display circuit, wherein the background image is stored in the display control chip.

14. The display control chip of claim 9, wherein the computing circuit is configured to receive a background image from an external video source, configured to overlay a first image of the plurality of images to the background image to generate display data, and configured to output the display data to the display circuit.

15. The display control chip of claim 9, wherein when the computing circuit receives the update data, the computing circuit outputs a default image of the display control chip to the display circuit.

16. A display system, comprising:
a memory, configured to store animation data, wherein the animation data comprises a plurality of images;
an input device, configured to generate update data;
a display circuit; and
a display control chip, comprising an on-screen display (OSD) buffer, configured to communicate with the input device for receiving the update data, and configured to use the update data to update the animation data;
wherein the display control chip is coupled to the memory and the display circuit, when the display control chip reads the animation data in the memory, the display control chip is configured to:
write the plurality of images into the OSD buffer sequentially; and
output the plurality of images to the display circuit sequentially, so as to form an OSD animation on the display circuit.

17. The display system of claim 16, wherein the OSD buffer comprises a plurality of sub-buffers, the display control chip is configured to write the plurality of images into the OSD buffer sequentially, and the plurality of sub-buffers are configured to sequentially receive the plurality of images written into the OSD buffer.

18. The display system of claim 16, wherein the OSD buffer is configured to use the same sub-buffer to store the plurality of images sequentially.

19. The display system of claim 16, wherein the animation data further comprises a plurality of playback times respectively corresponding to the plurality of images, and the display control chip is configured to write the plurality of playback times respectively with the plurality of images into the OSD buffer sequentially.

20. The display system of claim 19, wherein the display circuit is configured to:
receive a first image of the plurality of images and a first playback time of the plurality of playback times corresponding to the first image from the OSD buffer;
make the first image display the first playback time;
during the time that the first image is displayed, receive a second image of the plurality of images and a second playback time of the plurality of playback times corresponding to the second image from the OSD buffer; and
make the first image display the first playback time.
